(19) United States
(12) Patent Application Publication
(10) Pub. No.: US 2002/0116717 A1
(43) Pub. Date: Aug. 22, 2002

(54) System and method for selling advertising space on electronic displays digital television using spectrum

(76) Inventors: Marc Eller, Dallas, TX (US); Zvi Yaniv, Austin, TX (US)

Correspondence Address: KELLY KORDZIK, WINSTEAD SECHREST & MINICK P.C., 5400 RENAISSANCE TOWER, DALLAS, TX, 75270, US

(21) Appl. No.: 09/784,394

(22) Filed: Feb. 15, 2001

Related U.S. Application Data
(63) Continuation-in-part of application No. 09/553,012, filed on Apr. 20, 2000.

(51) Int. Cl. G06F 3/00; H04N 5/445; G06F 13/00; H04N 7/173; H04N 7/16

(52) U.S. Cl. 725/105; 725/147; 725/117

(57) ABSTRACT

Electronic billboards, which may be indoor or outdoor are located in various geographical areas. Associated with each billboard is a web address. A client desiring to display information, such as an advertisement, on any selected electronic billboard can upload the information over a digital television broadcast network to the server implementing the billboard website. The client can select the time and duration for the information to be displayed, and can even purchase the display time using a credit card or through the use of some other type of account.

### CROSS-REFERENCE TO RELATED APPLICATIONS

The present Application is a continuation-in-part application of U.S. patent application Ser. No. 09/553,012 filed Apr. 20, 2000, entitled “System and Method for Selling Advertising Space on Electronic Billboards over the Internet”.

### TECHNICAL FIELD

The present invention relates in general to computer networks, and in particular, to transmitting information to displays using wireless digital television broadcasts.

### BACKGROUND INFORMATION

Electronic billboards are poised to transform the billboard industry by permitting multiple ads to be displayed on an electronic billboard at any desired time and frequency. Moreover, the transportation of the ads to a particular billboard can be made using any type of electronic means, including wireless transmission.

### SUMMARY OF THE INVENTION

The present invention permits a user to access the billboard provider's website to order and upload a desired ad to a particular billboard anywhere within the world.

More specifically, an advertiser can upload advertising data to a server operating a particular billboard via a remote computer. Once approved for content, the advertising data can then be transmitted to the billboard for display at a time and duration selected by the advertiser.

The billboard to display the advertising information can be located indoors or outdoors.

Though the present invention is described with respect to the display of advertisements, any information, including video and still images can be uploaded and displayed on the indoor or outdoor billboards in accordance with the present invention.

In an alternative embodiment, the uploading of the information to the indoor or outdoor billboards can be performed using wireless communications. One method of wireless communication uses digital wireless transmissions from digital television broadcasters broadcasting digital television within a local area.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates an example of billboard locations within the continental United States;

FIG. 2 illustrates an electronic billboard;

FIG. 3 illustrates a flowchart configured in accordance with the present invention;

FIG. 4 illustrates a process for enabling a viewer of a billboard to receive other information about products advertised on that particular billboard;

FIG. 5 illustrates an architecture for transmitting data to and from various billboards;

FIG. 6 illustrates an embodiment of the present invention; and

FIG. 7 illustrates further detail of an embodiment of the present invention.

### DETAILED DESCRIPTION

In the following description, numerous specific details are set forth to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted in as much as such details are not necessary to obtain a complete understanding of the present invention and are within the skills of persons of ordinary skill in the relevant art.

Refer now to the drawings wherein depicted elements are not necessarily shown to scale and wherein like or similar elements are designated by the same reference numeral through the several views.

Outdoor billboards are located throughout the United States and even worldwide. Traditionally, billboards have been of the paper/poster type, where the ad on the billboard must be manually changed on a periodic basis using one or more workers. As a result, for a definitive period of time, usually one month or longer, only a single ad can be displayed on any particular billboard.

Indoor billboards are also gaining a foothold by displaying on the inside walls, or other locations, information about products and special sales within the store. Again, the problem with such traditional posters and indoor billboards is that they must be manually changed, thus limiting their versatility and effectiveness.

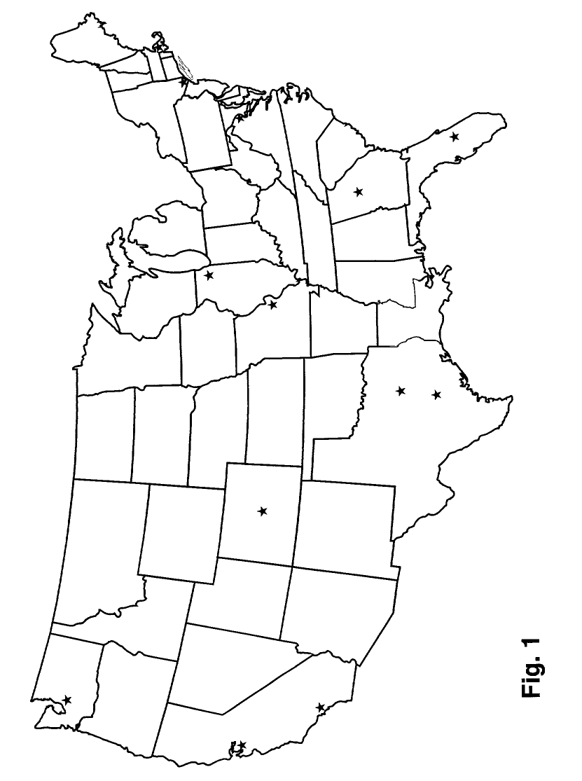

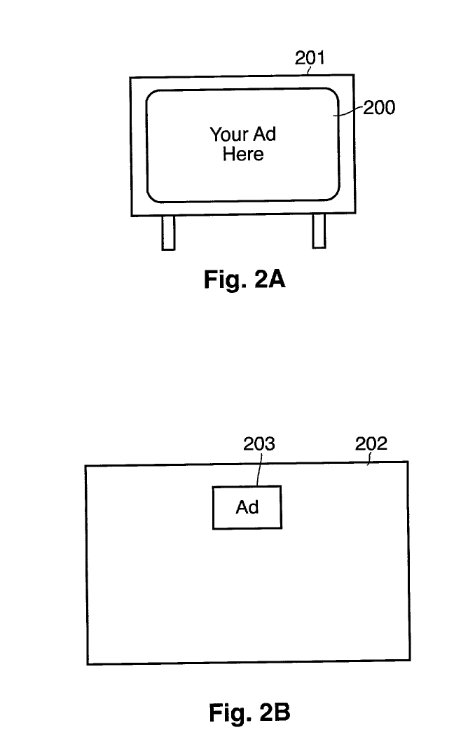

Electronic billboards, such as the ones illustrated in FIGS. 2A and 2B, have the capability of displaying still or video images in a manner similar to a television or a computer display. FIG. 2A illustrates an outdoor billboard 201 having an electronic display 200 configured in accordance with one embodiment of the present invention. FIG. 2B illustrates an indoor electronic billboard 203 for displaying advertising information, or any other information, on a wall 202 of the inside of the store. A processor and memory device, along with driver electronics and software are located at the electronic billboard site. The images to be displayed can be stored within the memory, and then are displayed in a desired manner using software. For example, a multitude of different ads can be displayed at different and preselected frequencies and durations of time. The ads can be uploaded to the billboard system through a direct connection locally, or remotely using landlines, cable, satellite signaling, fiber optic cable, wireless transmissions, etc. As a result, a central location can upload various ads to various billboards located across the United States (FIG. 1 illustrates an example of electronic billboards, noted by X's, throughout the United States), or even worldwide. Alternatively, any one or more of the billboards noted by the exemplary locations on FIG. 1 could be indoor billboards as described above.

The further advantage of the present invention is that it permits a client who wishes to purchase ad space on a particular electronic billboard to do so completely, or almost completely, without the intervention by the billboard provider.

Alternatively, a company utilizing indoor, or outdoor, billboards at store locations in various geographic areas, could upload any desired information to any selected billboard remotely. For example, if a particular company decided to run a Labor Day sale, it could merely upload an ad describing such sale to selected billboards at selected stores throughout the world.

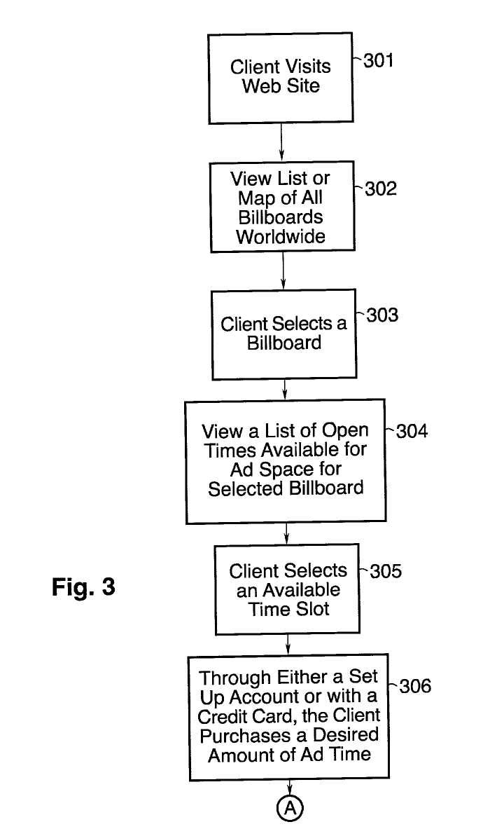

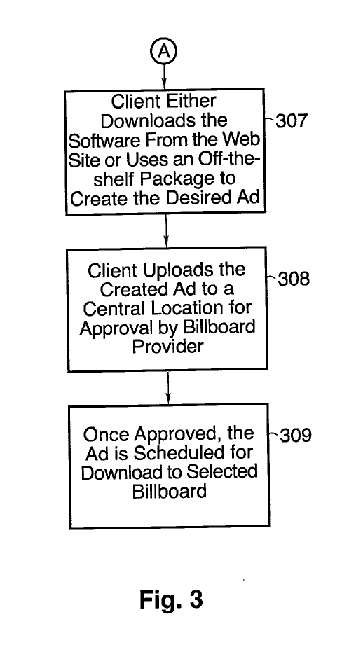

Referring to FIG. 3, a client who wishes to display their ad on a particular billboard somewhere within the world will log onto a network, such as the Internet or the Internet 2, and visit the website operated by the billboard provider. In step 302, the client may view a map of the United States, any other country, or even the entire world with indications where the billboard provider's electronic billboards are located. Using a zoom feature, the client may zoom in on a particular location, such as New York City, to pinpoint the location of the electronic billboard, down to the precise city block. Furthermore, the client may view a photo of the billboard showing the billboard height, width, the direction the billboard is facing, etc. Alternatively, even an image of an indoor billboard can be displayed to the client.

In step 303, the client will select a billboard. In step 304, a list of open times and their durations available for ad space at the selected billboard is provided to the client. The client, in step 305, can then select an available time slot and duration. Upon selection of the available time slot and duration, the cost for the ad space may be provided to the client in those instances where a fee is applicable. Such a fee may be dependent on several factors, including the time of day during which the ad will be displayed.

In step 306, the client will purchase the desired amount of time (if applicable). Such a purchase could be made with a credit card, or the clients may already have an account set up with the billboard provider. Alternatively, a password could be required to be entered before being able to upload any software to the billboard.

In step 307, the client proceeds to prepare their own ad (or other information to be displayed) for display. As an alternative, the client may already have an ad, which the client may upload to the billboard provider. If the client needs to prepare an ad, it may do so using prepackaged software, such as PowerPoint™, or a software package may be downloaded from the billboard provider, which enables the client to create an ad. Once the ad is created, then the client may upload the created ad to a central location for approval by the billboard provider in step 308. It is contemplated that such an approval will be required so that the billboard provider can ensure that the displayed ad conforms to the local laws where the billboard is located. Nevertheless, certain pre-approved clients may be able to skip step 308 and upload their ad directly to the billboard system.

In step 309, once approved, the ad is scheduled by the billboard provider for downloading to the selected billboard system for display at the desired time and duration. Furthermore, a software key may be used by the billboard provider to ensure that only their own secure transmissions are sent to the billboards.

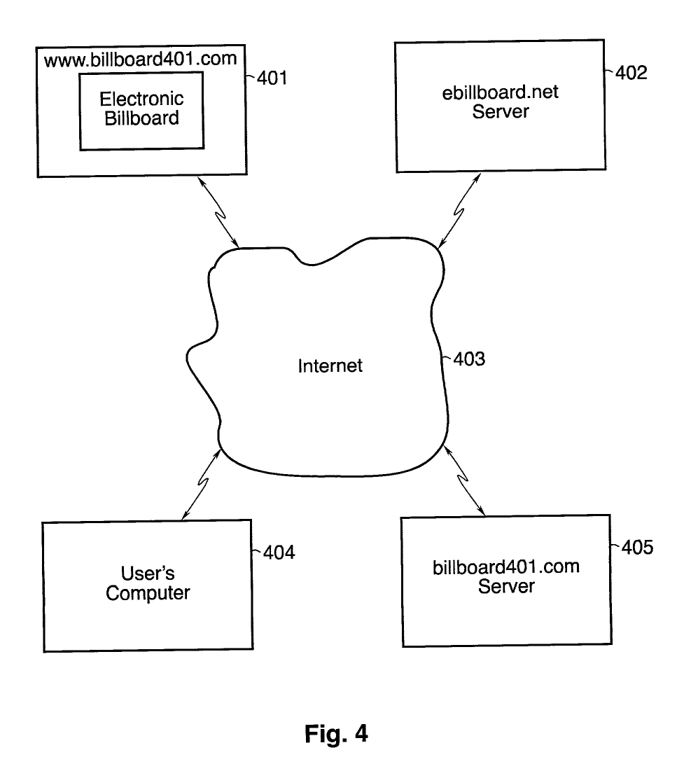

Referring to FIG. 4, electronic billboards, such as electronic billboard 401 can be located anywhere within the world. In addition, each billboard may have its own website associated with it, wherein the website will be supported by server 405. Server 405 will maintain the web page for billboard 401, and will be accessible by a user over the Internet 403 by going to www.billboard40l.com. In the process described above with respect to FIG. 3, an option may be given to the advertiser to provide further information regarding the ad to be displayed on billboard 401. Such additional information may include details about the product advertised, links to other web sites, etc. If the advertiser uploads such information, the ebillboard.net server 402 will then subsequently download that information to billboard 401.com. Subsequently, when an individual views that particular advertisement on billboard 401, somewhere on billboard 401 there will be a message that further information regarding products shown on the billboard 401 can be found at billboard4Ol.com. T his message could be displayed by the electronic billboard, or could merely be printed on the border of billboard 401. Then, when the person gets to their computer 404, and they access billboard 401.com, they will be able to view the additional information provided by the advertiser. The foregoing will be performed for each individual billboard throughout the entire world, wherein each such billboard will have its own web page.

Each billboard could also broadcast, on particular wireless frequencies to passers by, information about the billboard or its ads, in a manner similar to the way airport information is broadcast to car radios when cars near an airport.

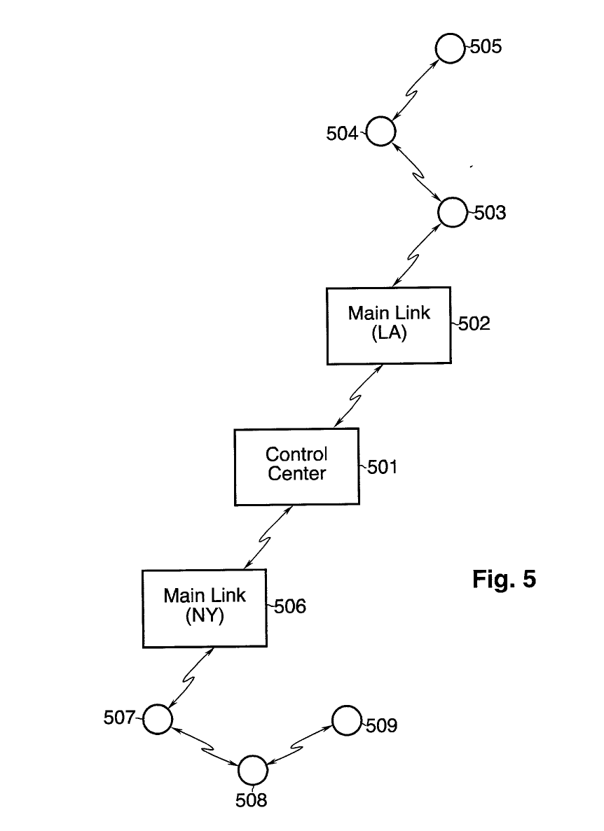

Referring to FIG. 5, one of the issues regarding implementation of electronic billboards is the transmission of the data to and from the billboards in a wireless mode. Although cellular, satellite, fiber and cable technologies can perform this function, another viable transmission medium is radio frequency (RF) waves. By using voice mobile channels, for example, which cover distances up to 15 miles, the system would be able to digitally repeat data messages for other data links and at the same time provide data input/output services at a node (billboard). A path could include up to several repeaters. As a result, the system could easily cover 120-150 miles from a source location, which is connected by telephone, cellular modem, satellite, etc. to a central control center. Such a central control center 501 may house the ebillboard.net server 402. The link to the main link 502 in one city (e.g., Los Angeles) could be made by any type of telecommunications means, as described above. Likewise, the connection between control center 501 and the main link 506 (e.g., New York) could also be made by any type of telecommunications link. Each main link will then have a wireless connection to a first repeater node 503, 507, which are then connected by a wireless connection to the next repeater node 504, 508, which could then be coupled to the next repeater node 505, 509 by another wireless connection. Each of these nodes involves a wireless repeater, and may be located at the various billboard sites within the particular locale. As a result, a main link can communicate with all the billboards within an area by wireless RF communications.

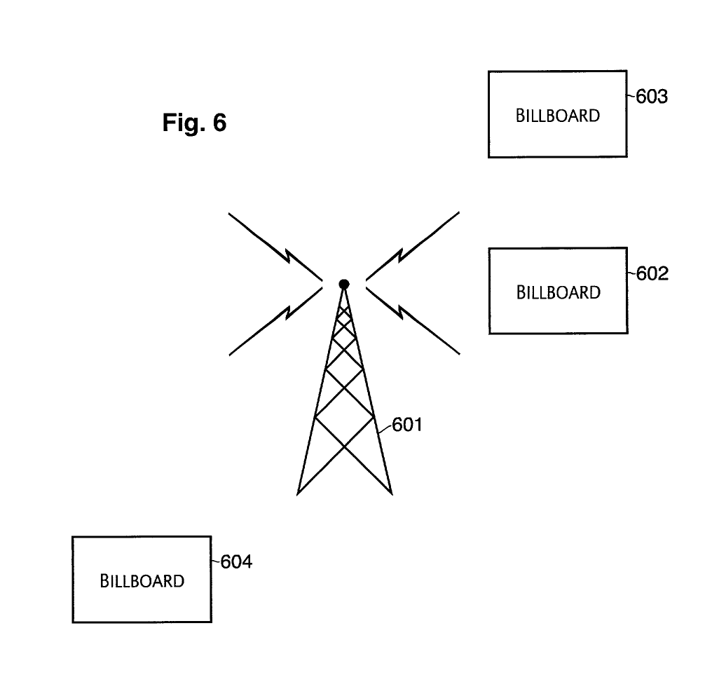

Referring to FIG. 6, there is illustrated an alternative embodiment for uploading information as previously described to one or more billboards (displays). Antenna 601 may be utilized by a local television broadcast station within a particular area, such as within a city and the surrounding counties. This antenna 601 is utilized by the local television broadcaster to broadcast one or more local television channels to consumers' television sets located within the viewing area. As television broadcasting technology continues to move toward the digital arena, digital television broadcasts will replace the previously utilized analog signals even for those consumers who are not able to make use of satellite or cable technologies. Digital television broadcasting in a wireless fashion from an antenna 601 is well known in the art, and can use such technologies as digital frequency modulation and standards approved by such entities as the National Television Standards Committee and the Advanced Television Systems Committee (ATSC).

A certain portion of the frequency band of the digital television transmission from antenna 601, which is not utilized to transmit the digital television signal to the television sets within the viewing area can be utilized to carry the advertising, or other information. Then when this digital television signal is received by billboards within the viewing area that have circuitry for decoding the carrier frequency carrying this information, such billboards, e.g., billboard 602-604, can decode the signal and display the information. Since the television sets will not have the decoders needed to decode this portion of the digital television signal, the television sets within the broadcast viewing area will not display this information. Furthermore, since it is well known in the art to be able to direct a broadcast signal to one or more lobes directed at certain geographical locations within an area, it can be possible to only send the information to certain ones of the billboards 602-604 within a specified geographical location.

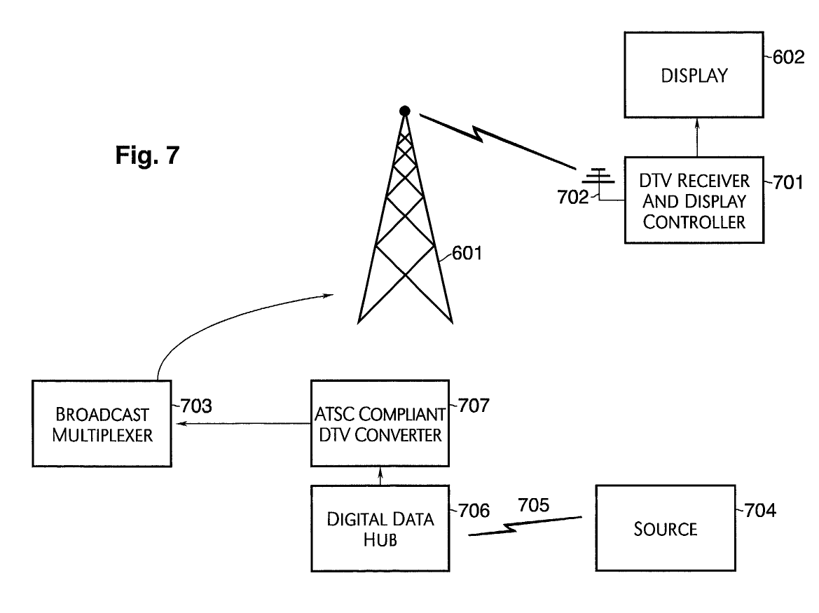

FIG. 7 illustrates further detail of the present invention where a source 704 for the information to be displayed on display 602, e.g., billboards 602-604, creates the information and sends it via a communications means 705 through a digital data hub 706 to an ATSC compliant DTV (digital television) converter 707. Converter 707 will convert the digital information into a format that can be transmitted wireless within the digital television spectrum. Broadcast multiplexor 703 will multiplex that signal with the digital television broadcast signal to be transmitted by tower 601. When that signal is received by antenna 702, DTV receiver 701 will decode the signal and parse out the information created by converter 707. This information will then be decoded for display on display 602 by the display controller 701.

Although the present invention and its advantages have been described in detail, it should be understood that various changes, substitutions and alterations can be made herein without departing from the spirit and scope of the invention as defined by the appended claims.

What is claimed:

1. A display system comprising:
an electronic display;
an information handling system coupled to the electronic display and operable for controlling what is displayed on the electronic display;
a digital television broadcast network coupled to the information handling system; and
a computer remotely located relative to the information handling system and coupled to the information handling system via the digital television broadcast network, the computer operable for receiving input for sending information over the digital television broadcast network to the information handling system for display on the electronic display.

2. The display system as recited in claim 1, wherein the electronic billboard is located so that it can be viewed by a plurality of people.

3. The display system as recited in claim 2, wherein the electronic display is an outdoor billboard.

4. The display system as recited in claim 2, wherein the electronic display is an indoor billboard.

5. The display system as recited in claim 1, wherein the digital television broadcast network includes a digital television broadcast transmitter for transmitting a digital television signal in a wireless manner, wherein a portion of spectrum of the digital television signal is carrying the information, and wherein the digital television broadcast network further includes a receiver antenna coupled to the information handling system for receiving the digital television signal, wherein the information handling system decodes the digital television signal to extract the information therefrom for display on the electronic display.

6. The display system as recited in claim 5, wherein the digital television broadcast transmitter includes a transmitting antenna coupled to a broadcast multiplexor that combines a signal carrying the information with the digital television signal.

7. The display system as recited in claim 1, further comprising:
a second electronic display;
a second information handling system coupled to the second electronic display and operable for controlling what is displayed on the second electronic display, wherein the digital television broadcast network is also coupled to the second information handling system so that the computer can upload information to be displayed to either or both of the electronic displays.

8. A method for displaying information on an electronic billboard, comprising the steps of:
creating the information;
uploading the information to a first information handling system from a second information handling system over a digital television broadcast network; and
controlling a display of the information on the electronic billboard by the second information handling system.

9. The method as recited in claim 8, wherein the digital television broadcast network includes a digital television broadcast transmitter for transmitting a digital television signal in a wireless manner, wherein a portion of spectrum of the digital television signal is carrying the information, and wherein the digital television broadcast network further includes a receiver antenna coupled to the information handling system for receiving the digital television signal, wherein the information handling system decodes the digital television signal to extract the information therefrom for display on the electronic display.

10. The method as recited in claim 9, wherein the digital television broadcast transmitter includes a transmitting antenna coupled to a broadcast multiplexor that combines a signal carrying the information with the digital television signal.

11. The method as recited in claim 10, wherein the electronic billboard is mounted for outdoor display of the information.

12. The method as recited in claim 10, wherein the electronic billboard is mounted for indoor display of the information.

13. The method as recited in claim 8, further comprising the step of mounting the electronic display for public viewing of the information to be displayed.

14. A method for displaying information on an electronic billboard, comprising the steps of:
providing a first electronic billboard at a first location;
coupling a first information handling system to the first electronic billboard so that the first information handling system can control information to be displayed on the first electronic billboard;
providing a second electronic billboard at a second location;
coupling a second information handling system to the second electronic billboard so that the second information handling system can control information to be displayed on the second electronic billboard;
coupling the first and second information handling systems to a third information handling system over a digital television broadcast network;
selecting, via the third information handling system, which of the first and second electronic billboards will display the information;
uploading the information from the third information handling system over the Internet to the information handling system controlling the selected electronic billboard; and
displaying the information on the selected electronic billboard.

15. The method as recited in claim 14, further comprising the steps of:
selecting, via the third information handling system, a time period for displaying the information on the selected electronic billboard; and
displaying the information on the selected electronic billboard during the selected time period.

16. The method as recited in claim 14, wherein the selected electronic billboard is selected from a list of available electronic billboards which includes the first and second electronic billboards.

17. The method as recited in claim 16, wherein the list includes a map of the first and second locations.

18. The method as recited in claim 16, further comprising the step of:
charging an amount of money for the display of the information on the selected electronic billboard.

19. A system for displaying information on an electronic billboard, comprising:
means for providing a first electronic billboard at a first location;
means for coupling a first information handling system to the first electronic billboard so that the first information handling system can control information to be displayed on the first electronic billboard;
means for providing a second electronic billboard at a second location;
means for coupling a second information handling system to the second electronic billboard so that the second information handling system can control information to be displayed on the second electronic billboard;
means for coupling the first and second information handling systems to a third information handling system over a digital television broadcast network;
means for selecting, via the third information handling system, which of the first and second electronic billboards will display the information;
means for uploading the information from the third information handling system over the Internet to the information handling system controlling the selected electronic billboard; and
means for displaying the information on the selected electronic billboard.

20. The system as recited in claim 19, further comprising:
means for selecting, via the third information handling system, a time period for displaying the information on the selected electronic billboard; and
means for displaying the information on the selected electronic billboard during the selected time period.
